(19) United States
(12) Patent Application Publication
(10) Pub. No.: US 2007/0200355 A1
(43) Pub. Date: Aug. 30, 2007

(54) Multi-point sliding door latch

(76) Inventors: Luke Liang, South Plainfield, NJ (US); Tong Liang, (US); David Chen, (US)

Correspondence Address: Thomas A. O'Rourke;Bodner & O'Rourke, LLP, 425 Broadhollow Road, Melville, NY, 11747, US

(21) Appl. No.: 11/454,159

(22) Filed: Feb. 15, 2006

(51) Int. Cl. E05C 19/10; E05C 7/00

(52) U.S. Cl. 292/24

(57) ABSTRACT

A multi-point door latch adapted to fit in the stile of a door. The multi-point door latch includes a pair of hooks that are allowed to rotably pivot around a pair of eccentric cams. The eccentric cams are allowed to rotate inside of apertures located through the hubs of the hooks. The eccentric cams are geometrically centered inside the hubs of the hooks, and are kept in position via pins that are eccentrically orientated through cams. The multi-point door latch also includes an opening for receiving a turning mechanism. In addition, the turning mechanism is connected to a pair of toothed gear wheels that mesh with a toothed bar. The toothed bar is connected to a synchronizing link which simultaneously rotates the hooks to either an engaged or disengaged position. The multi-point door latch also includes stopping members, which prevent the hooks from rotating passed a certain point when the door latch is not engaged.

### FIELD OF THE INVENTION

This invention relates to multi-point door latch and more particularly to a multi-point door latch appropriate for use with sliding doors.

### BACKGROUND OF THE INVENTION

Generally, sliding doors may be kept in a latched position when a latch, preferably mounted on the locking side of the stiles of sliding doors, having a hook or other similar element, engages a keeper on the coupled door jamb. Unlike a single-point door latch that provide the engagement between only one hook or similar element and corresponding keeper, the multi-point latch may engage two or more hooks or similar elements and corresponding keepers. In order to increase the safekeeping function of the latch, at least two hooks should face each other. Such arrangement would preclude vertical movement of doors and therefore, disengagement of a latch and a keeper. There are several inventions that embodied an idea of the latch with hooks facing each other. Most of them include simultaneous operation of two hooks positioned in vertically spaced housing. Hooks are usually pivotally mounted in such manner that movement of a thumb turn key generate corresponding pivotal movement of a twin actuator that in turn activates upper and lower actuators interconnected with upper and lower hook correspondingly. Typically, a gang link connects twin actuator with upper and lower actuators. As a result, most of prior inventions utilize a set of relatively complicated and space-demanding mechanisms to convey a pivotal movement from a thumb turn-key to a twin actuator to upper and lower actuators and thus to retract hooks to engage corresponding keepers. The current invention provides a simple and compact packaging for a latch while avoiding complication of contemporary latches and at the same time does not compromise the security of multi-point door latches.

### SUMMARY OF THE INVENTION

The invention may fit in an opening of a lock face of a stile of a sliding door and may be arranged for co-action with a keeper positioned on associated jamb as well as for co-action with a thumb turn-key through generally rectangular drives slots of the hubs sized generally to receive tail member of a thumb turn-key.

According to a further feature of the invention, a thumb turn-key may be mounted on the inside surface of the sliding door. A latch may have a housing assembly, upper and lower hooks, and central actuator operative in response to turning movement of tail member to move upper and lower hooks from latched or retracted position to unlatched position; upper and lower cams positioned within upper and lower hooks correspondingly, a link that simultaneously connects central actuator with upper and lower hooks upper and lower cams.

According to a further feature of the invention, the housing may have two rectangular plates forming two walls that may define a vertically elongated hollow interior. These walls may be held together by rivets. The housing may be sized to fit within the opening in the lock face of a stile of a sliding door.

According to a further feature of the invention, actuator assembly may include an actuator and a synchronizing link. The actuator may be in form of a rack-and-pinion, or an arrangement of a toothed bar that meshes with gear wheel or wheels. One embodiment may include a toothed bar that meshes with two segments of the gear wheel. Each segment may be in form of pivot arm and include a toothed portion and a hub portion. Hub portion of a gear wheel may define trunnions for journaling in suitable apertures in the walls of the housing so as to mount the hub portions of pivot arms for rotation within the housing around pivot axis. Hub portions of the segments may include a rectangular drive slot sized to drivingly receive tail member of the thumb turn-key, and may extend from wall to wall of the housing. The tooth portion of each segment may have several teeth that meshes with the toothed bar in such manner that rotation of the tail member would cause rotation of either segment around its axis, the teeth of segment gear may engaged the toothed bar to move, engaging the second geared segment. Thus, one embodiment may be configured in such way that the rotation of the tail member causes synchronized rotation of geared segments. The toothed bar may be firmly connected with the synchronizing link in such manner that turning movement of the tail member causes the synchronizing link to move in vertical direction along walls of the housing. The synchronizing link may engage both upper and lower actuator as well as upper and lower hooks.

According to a further feature of the invention, upper and lower hooks may have a hook portion, an aperture, and a hub portion. An aperture may be configured in the hub portion of the hook. Upper hook may have a pivotal eccentric cam sized to fit the aperture portion of the hook. The pivotal eccentric cam may be configured to freely rotate within the upper hook's aperture independently from the hook. The hook may rotate around the eccentric cam. The eccentric cam may have a pivotal pin that extends outwardly from both sides of a cam. The ends of both sides of the pin may be rotatably positioned within corresponding aligned apertures made in the both walls of the latch. The geometric center of the pivotal pin of the eccentric cam may be displaced from the geometric center of the eccentric cam. The cam may rotate around a pivotal pin's axis. Therefore, because of such configuration of the hook, eccentric cam and the pin, the revolving movement of the cam within the aperture of the hook may cause the latter to move back and forth in the direction perpendicular to the axis of rotation of the cam if the hook does not revolve along with the cam.

According to a further feature of the invention, the hub portion of an upper hook may have protrusions. An upper eccentric cam may have grooves and protrusions. The hub portion of the upper hook and the upper cam may be interconnected through such grooves and protrusions. It will be seen that turning movement of the cam may move the hub portion, and therefore, the upper hook around the pivotal pin. The geometric center of the hub portion of the upper hook may coincide with geometric center of the eccentric cam. Thus, if the hook revolves around the eccentric cam, such movement may cause the upper hook to travel forwardly and rearwardly within the hollow of the housing to unlatched and latched positions. Similarly, if the eccentric cam engages the hook through the hub portion and the eccentric cam turns around the pivotal pin along with the hook, such turning movement may cause the upper hook to revolve forwardly and rearwardly around its geometrical center within the hollow of the housing in the direction perpendicular to the revolving movement of the hook.

According to a further feature of the invention, the hook portion, the aperture portion and the hub portion of the lower hook may be identical to the upper hook except for their orientation within the housing as well as number and positioning of protrusions. When the hooks are in their latched or retracted position, the hook portion of the upper hook may point downwardly and the hook portion of the lower hook may point upwardly.

According to a further feature of the invention, a synchronizing link may be in a form of generally elongated rectangular plate that may move vertically along an inner side of one plate of the housing. A synchronizing link may extend from a lower hook to an upper hook in parallel relation to the inner side of the front wall of the latch housing. The synchronizing link may have a protrusion on its lower portion that may activate a lower hook and the other protrusion on its upper portion that may activate an upper hook through a rocker arm and a pushrod. Also, the synchronizing link may have cuts of such shape that surfaces formed by those cuts may engage both upper and lower eccentric cams at the certain point relative to the engagement of upper and lower hooks upon the movement of the synchronizing link.

According to a further feature of the invention, the turning movement of the thumb turn-key may engage an actuator. The rotation of geared wheels may move a geared bar. Because a synchronized link is firmly connected to a geared bar, the rotation of the thumb turn-key may cause the back-and-forth movement of a synchronizing link in the vertical direction along walls of the housing of a latch.

According to a further feature of the invention, the synchronizing link may engage both upper and lower hooks; it may engage the upper hook through a rocker arm, a pushrod and a protrusion made at the tip of the upper portion of the synchronizing link, and the lower hook through a protrusion made on the inner surface of the lower portion of the synchronizing link. It will be shown that when a turn-key is rotated from unlatched toward latched position a synchronizing link may move upwardly along walls of a housing of a latch. A protrusion made on the tip of the upper portion of the synchronizing link may engage the suspended end of the rocker arm pushing it upward. The opposite end of a rocker arm is pivotally connected to the pushrod which in turn pivotally connected to the hub portion of the upper hook. Because an upper hook is pivotally positioned on the pivotal eccentric cam and may rotate around it, the vertical movement of a pushrod causes the hub portion of an upper hook to rotate around an eccentric cam. Such vertical movement of the synchronizing link may be limited by the travel limiter that may be passed through the elongated aperture made in the upper portion of the synchronizing link and extends through the upper portion of the link in parallel relation to the link. The upper hook may revolve from unlatched vertical position to horizontal latched position in perpendicular relation to the synchronizing link. At the point an upper hook revolves for approximately 90 degrees from unlatched position, the further movement of the synchronized link and therefore the revolving movement of the upper hook are stopped when the travel limiter is pressed against the lower edge of the elongated aperture made in the upper portion of the synchronizing link. A travel limiter, an elongated aperture and their positioning in the lower portion of the synchronizing link may be identical to these of an upper one.

According to a further feature of the invention, an eccentric pivot cam may have a flange around one side of the cam. The flange may secure the positioning of the cam within the aperture portion of the hook from one side. The washer that may be frictionally insertably positioned on the cam upon the opposite side may secure the positioning of the cam within the aperture portion of the hook from the other side. The washer of the lower cam may have an extension that may co-act with the protrusion present on the rear edge of the front wall of the plate to prevent the further up-right rotation of the lower hook. The up-right position of both hooks may be necessary to lock both hooks on the latched position. Such locked position of hook may be achieved by moving both hooks in the direction perpendicular to axis of their rotation. The locked position of both hooks may be provided by rotation of the upper and lower cams relative to the upper and lower hooks. The off-center positioning of the center of rotation of such cams would cause both hooks to move toward the back edges of the plates maintaining their up-right position relative to the plates until protrusion made on the rear edges of both plates co-act with hub portions of both hooks and prevent the rotation of such hooks backward to unlatched position. The locked position of both hooks would add extra-security to the latch.

### BRIEF DESCRIPTION OF THE DRAWINGS

FIG. 1 is a perspective view of the multi-point door latch engaged with a keeper.

FIG. 2 is an exploded view of the multi-point door latch.

FIG. 3 is a magnified view of the hooks of the multi-point door latch.

FIG. 3a is a magnified view of the eccentric cams of the multi-point door latch.

FIG. 4 is an orthographic view of the eccentric cam of the multi-point door latch.

FIG. 5 is side view of the eccentric cam of the multi-point door latch.

FIG. 6 is side view of the multi-point door latch, with the spring biasing one of the eccentric cams in a locked position.

FIG. 7 is side view of the multi-point door latch, with the spring biasing one of the eccentric cams in a unlocked position.

FIG. 8 is a front side view of the multi-point door latch, with the hooks in a closed position.

FIG. 9 is a front side view of the multi-point door latch, with the hooks pivoting toward an opened position.

FIG. 10 is a front side view of the multi-point door latch, with the hooks in an opened position.

FIG. 11 is a reverse side view of the multi-point door latch, with the hooks in an opened position.

FIG. 12 is a reverse side view of the multi-point door latch, with the hooks pivoting toward a closed position.

FIG. 13 is a reverse side view of the multi-point door latch, with the hooks in a closed position.

FIG. 14 is a side view of the multi-point door latch, with the hook engaged with a stopping member.

FIG. 15 is a side view of the multi-point door latch, with the hook disengaged from the stopping member

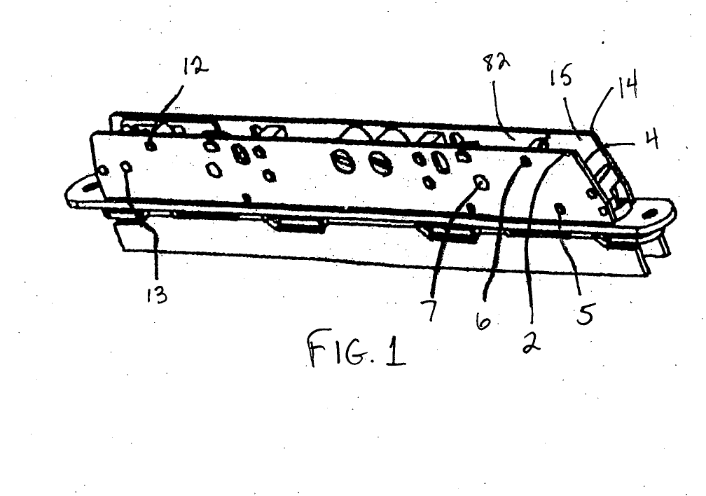

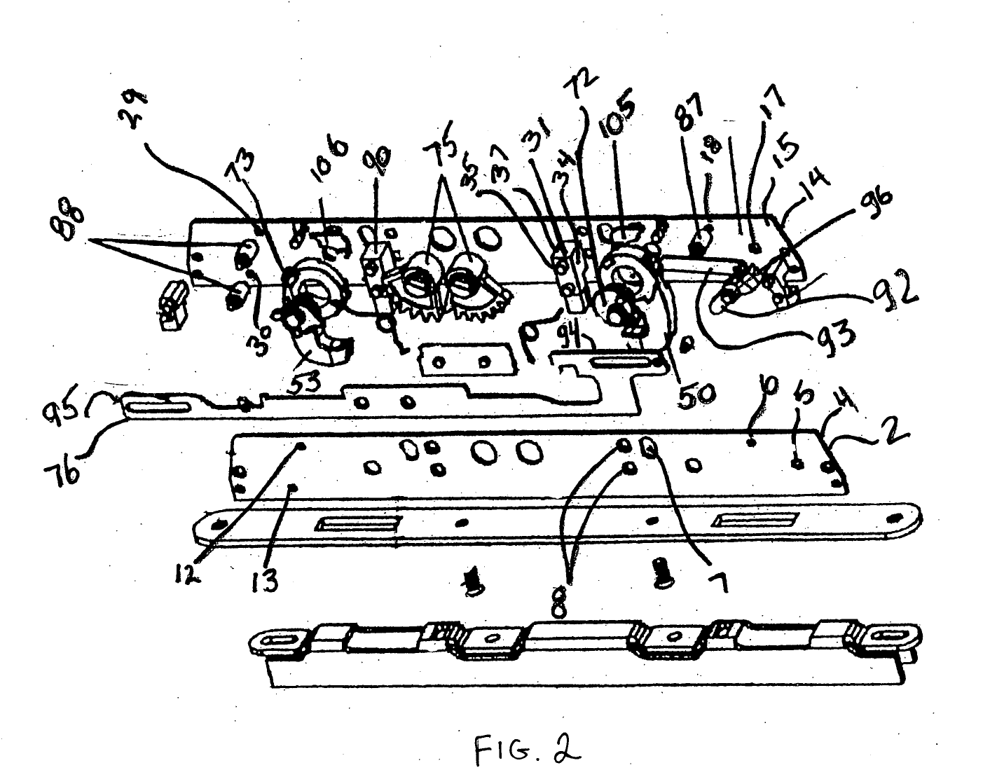

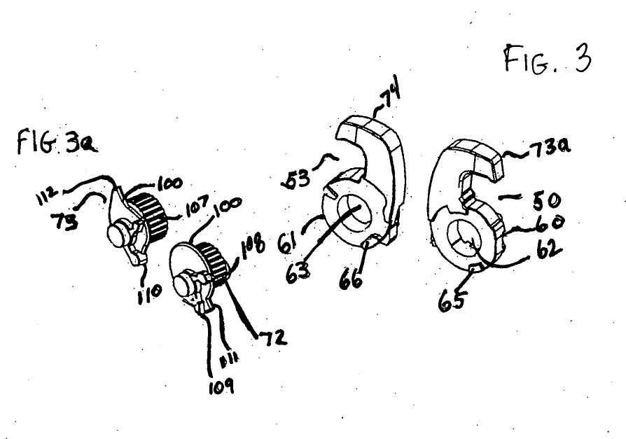

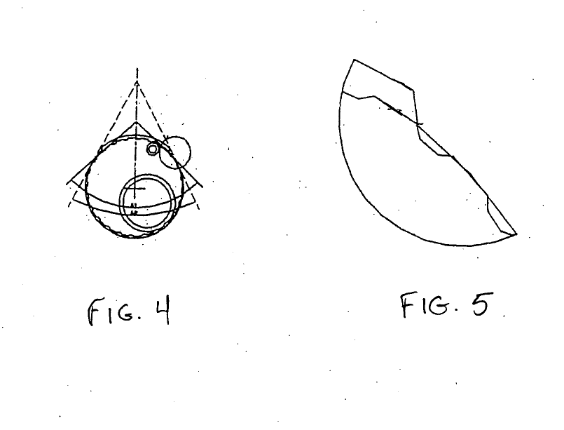

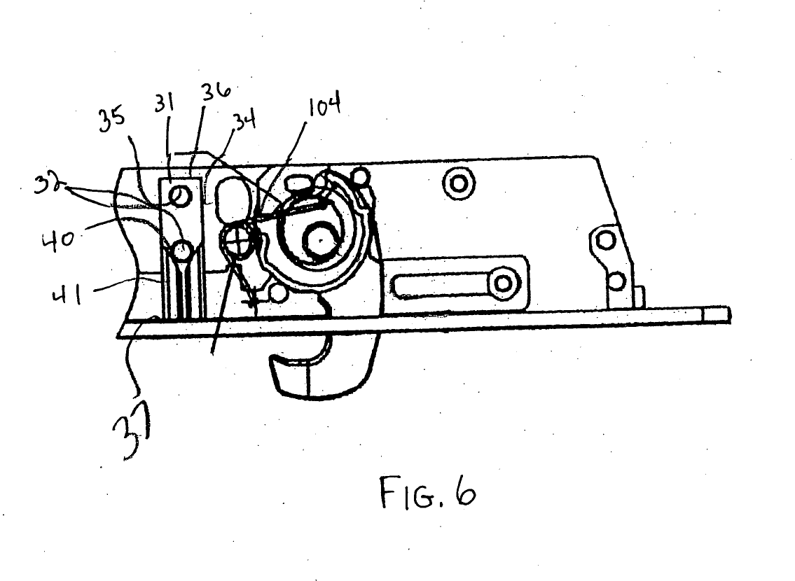

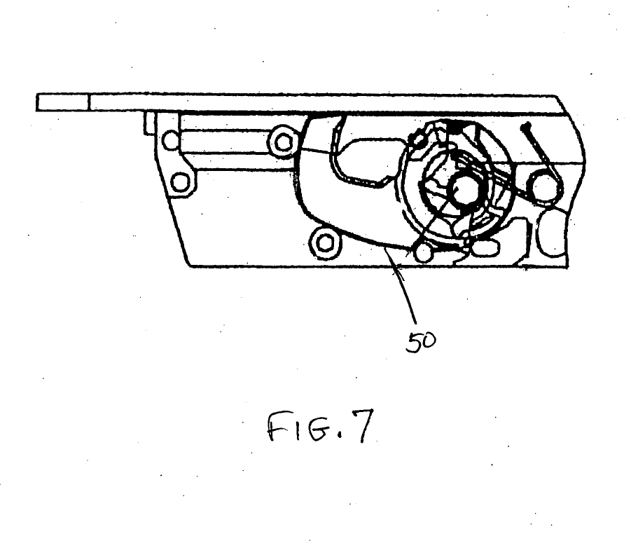

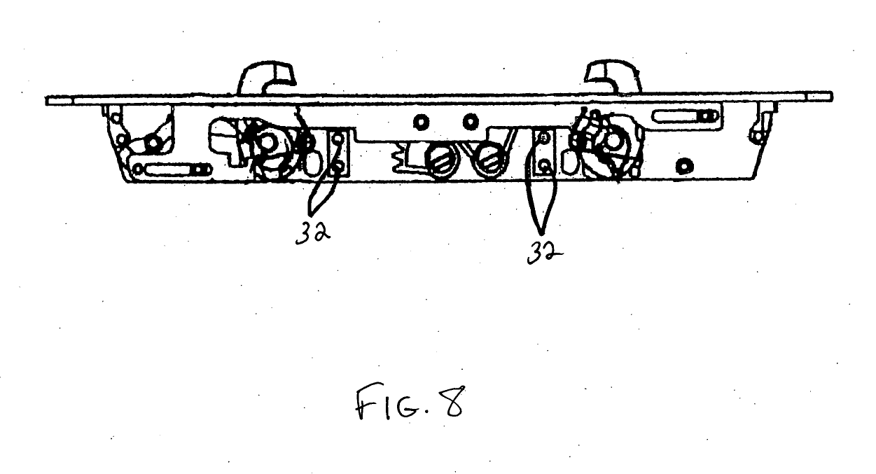

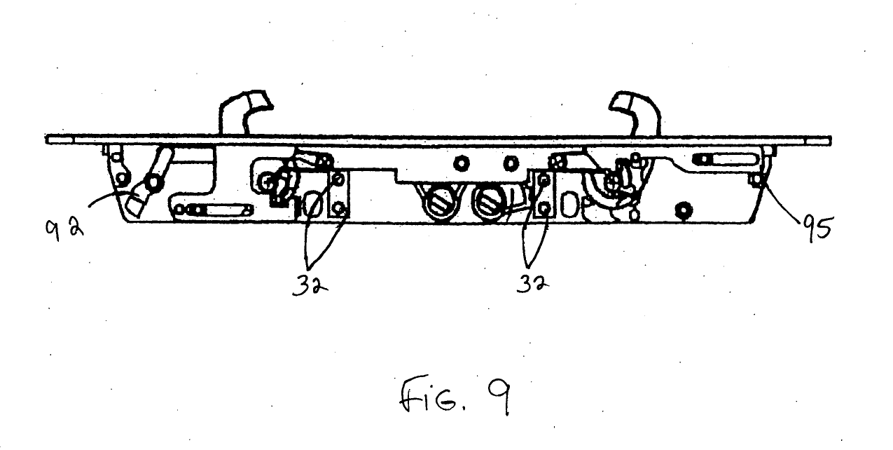

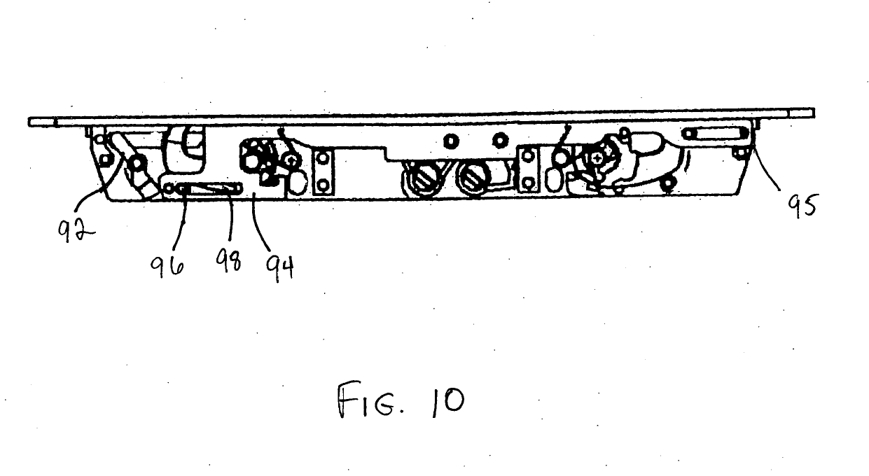

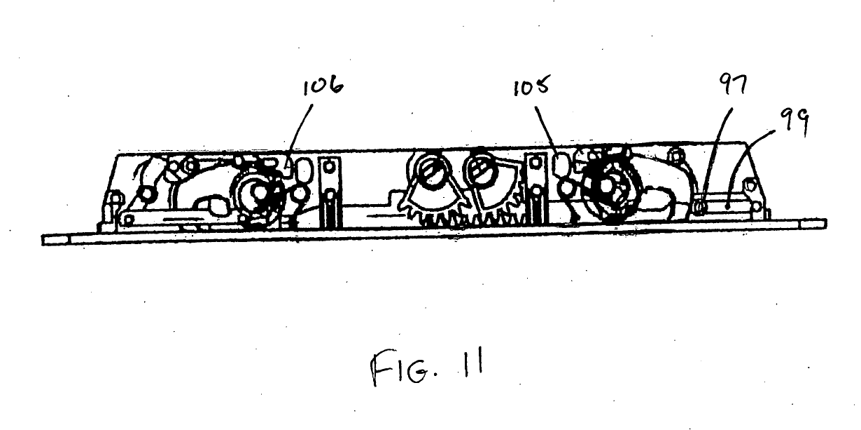

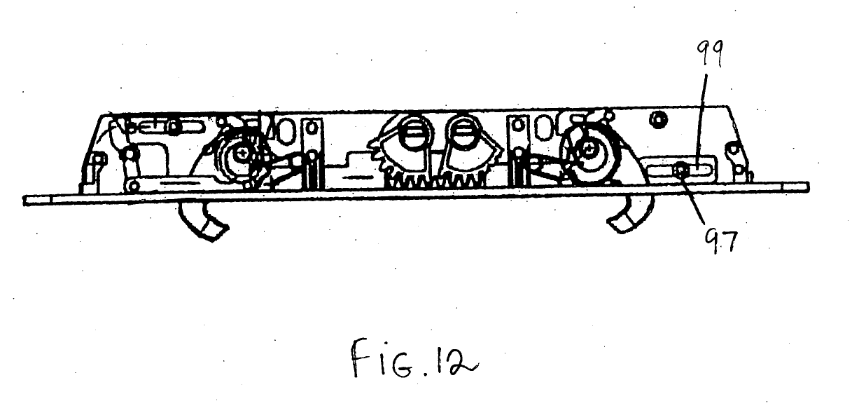

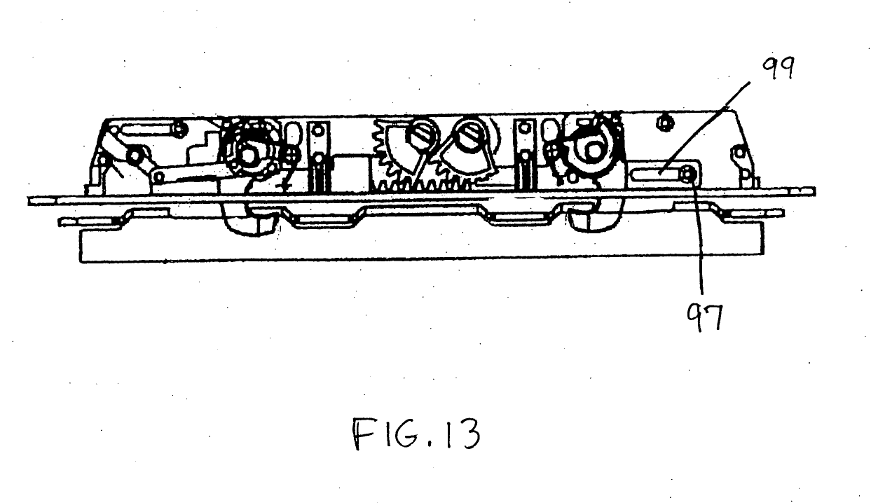

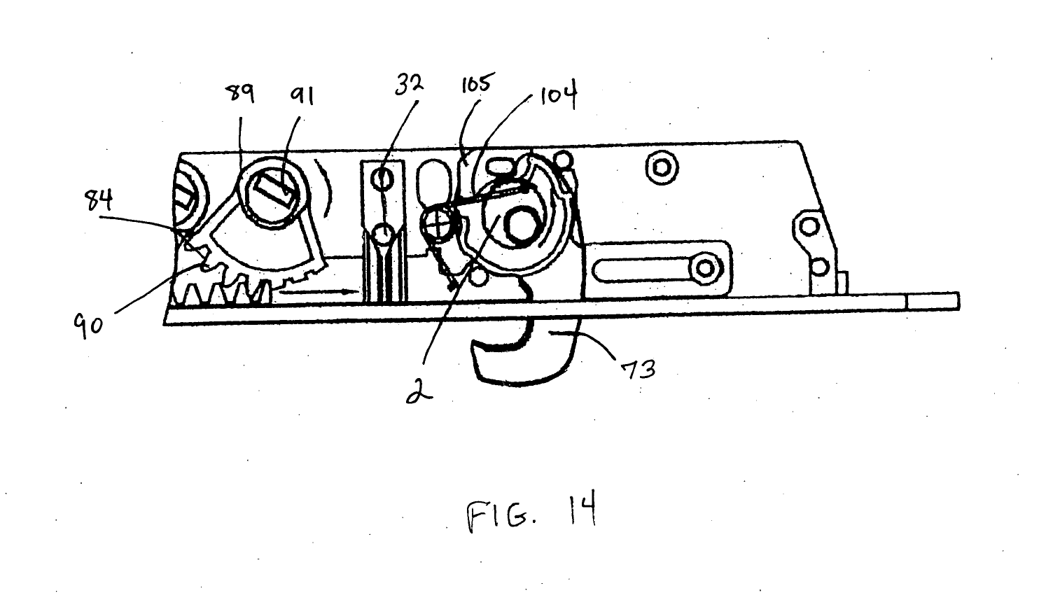

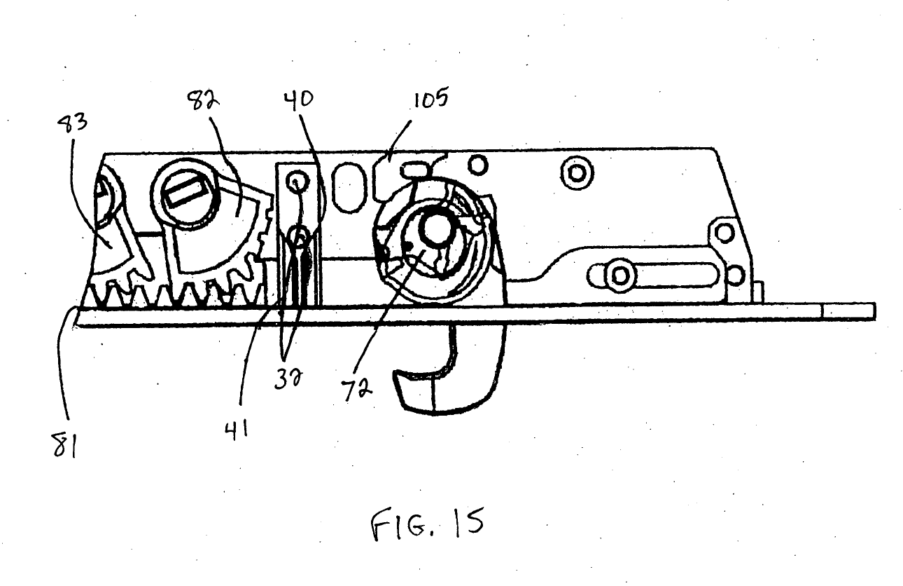

### DETAILED DESCRIPTION OF THE PREFERRED EMBODIMENT

A latch may have a housing assembly 1 which in turn may have an upper hook 50, a lower hook 53, central actuator 71 operative in response to turning movement of tail member of the thumb turn-key to move upper and lower hooks 50 and 53 from latched or retracted position to unlatched position; an upper eccentric cam 72 and a lower eccentric cam 73 positioned within upper and lower hooks 50 and 53 correspondingly, and a synchronizing link 76 that simultaneously connects central actuator 71 with upper and lower hooks 50 and 53 and upper and lower eccentric cams 72 and 73.

The housing may have two generally rectangular plates 2 and 14. The rear wall 4 of the plate 2 and the front wall 15 of the plate 14 may define a vertically elongated hollow interior 82. The housing assembly may be sized to fit the space flanked by the rear wall 4 of the plate 2 and the front wall 15 of the plate 14 or otherwise provided by the hollow interior 82. The plates 2 and 14 may be aligned in parallel relations by the upper elongated separator 31, the lower elongated separator 40, the upper traverse separator 83 and by lower traverse separator 84. The housing may be sized to fit within the opening in the lock face of a stile of a sliding door.

The upper elongated separator 31 may have generally rectangular shape and may be positioned in the perpendicular relation to both plates 2 and 14. The upper elongated separator may be generally defined by two elongated sides 34 and 35 which are positioned in parallel relations to each other, by surfaces 36 and 37 and by surfaces 38 and 39. The present embodiment of the side 34 may have two sections. Sections 40 and 41 may be separated by a step formed by surfaces that form a 90 degrees angle. It would be shown later that such configuration of the side 34 may be necessary to provide the space between the rear wall 4 of the plate 2 and the upper elongated separator 31 for friction free movement of the synchronizing link between such rear wall 4 and the section 41 of the side 34 of the upper elongated separator 31. Section 40 of the side 34 may be adjacent and run parallel to the rear wall 4 of the plate 2. Section 40 may have protrusions 32 generally cylindrical in shape extending outwardly and sized to insertably receive apertures 8 of the plate 2 of the assembly 1. The length of the protrusions 32 may be such that when the protrusions 32 are inserted into corresponding apertures 8 of the plate 2, it would be possible to make heads on the protruding from the rear wall 4 of the plate 2 ends of the protrusions 32 and thus to secure the upper elongated separator 31 to the plate 2. The side 35 of the separator 31 may be parallel to the side 34 and may extend through the entire width of the plate 2 and may have one section or have two sections in order to reduce the weight of the separator. The present embodiment of the side 35 of the upper separator 31 may have two sections. The configuration of these sections 42 and 43 may be identical to the sections 40 and 41 of the side 34 of the separator 31. The section 42 may have two protrusions 32 identical to protrusions on the section 40 of the side 34 and where protrusions 32 are inserted into corresponding apertures on the plate 14 aligned with apertures made in the plate 2 and then the heads may be formed on their protruding ends. The lower separator 44 may be identical to the upper separator 31. Although positioning of either separator relative to plates 2 and 14 may vary, in the present embodiment both separators are positioned symmetrically relative the geometrical center of the plates 2 and 14 and in such way to minimize the interference with other parts of the housing assembly.

There may be additional separators positioned on the periphery of plates 2 and 14 to help to maintain equal distance between the plates. The present embodiment may have two separators 87 and 88 generally in shape of a cylinder. Such cylinder may have their height generally equal to the desired width between the plates 2 and 14 and the distance between section 40 and 42 of the elongated separator to keep the same distance between the plates. Maintaining equal distance between plates through the length of the plates may allow jam-free interaction of the different elements of the latch. Separators 87 and 88 may have extensions from each end and may be sized to insertably receive paired aligned apertures and the length of such extensions may be sufficient to allow forming heads on the protruding from outer walls of plates ends of the extensions. It will be shown later that these traverse separators may also function as pivotal axis or travel limiter for the synchronizing link. The quantity and the positioning of traverse separators relative to plates 2 and 14 may vary.

A housing assembly 1 may include a central actuator 75 that may have trunnions 85 and a synchronizing link. The trunnions 85 may be sized to receive tail member of the thumb turn-key in order to co-act when such turn-key is rotated. The purpose of the central actuator 75 is to convert the revolving movement of the key-turn into the vertical movement of the synchronizing link 80 in order to engage hooks 54 and 57. The central actuator may be embodied as a rack-and-pinion, or an arrangement of a toothed bar that meshes with gear wheel or wheels. The present embodiment may have a toothed bar 81 that meshes with two segments of the gear wheel 82 and 83. Each segment may be in form of pivot arm and include a toothed portion 84 and a hub portion 89. Hub portion of a gear wheel 89 may define trunnions 85 for journaling in suitable apertures in the plates 2 and 14 of the latch so as to mount the hub portions 89 of pivot arms for rotation within the housing around pivot axis. Hub portions 89 of the segments may include a rectangular drive slot sized to drivingly receive tail member of the thumb turn-key, and may extend from front wall 3 of the plate 2 to rear wall 16 of the plate 14 of the housing. The toothed portion 84 of each segment may have several teeth 90 that mesh with the toothed bar 81 in such manner that rotation of the tail member would cause rotation of either segment around its axis, the teeth 90 of segment gear 82 and 83 may engage the toothed bar 81 to move, engaging the second geared segment. Thus, one embodiment may be configured in such way that the rotation of the tail member causes synchronized rotation of geared segments 82 and/or 83. The toothed bar 81 may be firmly connected with the synchronizing link 80 in such manner that turning movement of the tail member causes the synchronizing link 80 to move in vertical direction along the inner face of plate 2 of the latch. The synchronizing link 80 may engage both upper and lower hooks 54 and 57 as well as upper and lower eccentric cams 76 and 77. It will be shown that simultaneous engagement of hooks 54, 57 and eccentric cams 76, 77 are necessary to provide secure locking function of the latch.

Upper and lower hooks 54 and 57 may be sized to be fitted to openings in the lock face of the stile of a sliding door and arranged for co-action with keepers positioned on the associated jamb. It will be understood that turning movement of the thumb turn-key revolves the gear wheels 82, 83 which moves vertically the toothed bar 81 along with attached synchronized link 80 that engages hooks 54 and 57 in turning movement from unlatched to latched, or retracted position to engage keepers on the associated jamb. Also, it will be understood that after the hooks 54 and 57 are rotated from unlatched to latched position, the further rotation of them is prevented by the travel limiters in order to secure hook in upright position. Then, such hooks may move to locked position in the direction perpendicular to their prior turning movement, when they co-act with eccentric cams. An upper hook 54 may have a hook portion 73, an aperture 62, and a hub portion 60. An aperture 62 may be configured in the hub portion 60 of the hook 54. Upper hook 54 may have a pivotal eccentric cam 76 sized to fit the aperture 62 of the hook 54. The upper pivotal eccentric cam 76 may be configured to freely rotate within the upper hook's aperture independently from the hook 54. The hook 54 may rotate around the eccentric cam. The eccentric cam 76 may have a pivotal pin 91 that extends outwardly from both sides of a cam 76. The ends of both sides of the pin 91 may be rotatably positioned within corresponding aligned apertures 7 and 19 made in the both plates 2 and 14 of the latch. The geometric center of the pivotal pin 91 of the eccentric cam may be displaced from the geometric center of the eccentric cam 76. The eccentric cam 76 may rotate around a pivotal pin 91 axis. It will be understood that, if the hook 54 does not revolve along with the cam or revolves at the different speed, then because of the configuration of the hook 54, eccentric cam 76 and the pin 91, the revolving movement of the eccentric cam 76 within the apertures 7 and 19 may cause the hook 54 to move in the direction perpendicular to the axis of rotation of the eccentric cam 76. The hub portion 60 of the upper hook 54 may have protrusions designed for co-action with the eccentric cam 76. Size and positioning of such protrusions may define at which stages of the revolving movement of the hook 54 it may co-act with such eccentric cam 76. An upper eccentric cam 76 may have protrusions. The hub portion 60 of the upper hook 54 and the upper cam 76 may be interconnected through such protrusions. It will be understood that turning movement of the cam 76 may engage the hub portion 60, and therefore, the upper hook 54 around the pivotal pin. The geometric center of the hub portion 60 of the upper hook 54 may coincide with geometric center of the eccentric cam 76. Thus, if the eccentric cam 76 revolves around its off-geometric center axis and the upper hook 54 either remains motionless or the speed of its turning movement is not equal to the speed of the turning movement of the cam 76, such interaction may cause the upper hook 54 to travel in the direction perpendicular to its rotation axis into the hollow of the housing to locked and unlocked positions. However, when speed and the direction of rotation of the hook 54 and the cam 76 coincide, the positioning of the hook 54 relative to the housing of the latch does not change and such turning movement may cause the upper hook to revolve forwardly and rearwardly around its geometrical center within the hollow of the housing.

The aperture portion 63 and the hub portion 61 of the lower hook 57 as well as protrusions made upon the lower hook 57 and the lower cam 77 may be identical to those of the upper hook 54 except for their orientation within the housing. When the hooks are in their latched or retracted position, the hook portion 73 of the upper hook 54 may point downwardly and the hook portion 74 of the lower hook 57 may point upwardly.

A synchronizing link 80 may be in a form of generally elongated rectangular plate that may move vertically along an inner side of plate 2 of the housing. A synchronizing link may be positioned in overlaying relation to the rear wall 4 of the plate 2 and may extend from a lower hook 57 to an upper hook 54 in parallel relation to the plates 2 and 14 of the housing. The synchronizing link 80 may have a protrusion 92 on its lower portion that may activate a lower hook 57 and the other protrusion 93 on its upper portion that may activate an upper hook 54 through a rocker arm 94 and a pushrod 95. The synchronizing link 80 may have cuts of such shape that the surfaces formed by those cuts may interact with both protrusions made in the upper and lower eccentric cams. It will be understood that the positioning of such protrusions on the eccentric cams 76, 77 are such that the synchronizing link moving vertically may engage such protrusion into turning movement at the certain point relative to the engagement by the same synchronizing link of upper 54 and lower 57 hooks. Such embodiment of the eccentric cams and the cuts made upon the synchronizing link may be necessary to provide the independent engagement of eccentric cams 76, 77 and upper and lower hooks 54, 57 respectfully relative to each other.

It will be seen that the turning movement of the thumb turn-key may move rotatably gear wheels 82 and 83. This rotation of geared wheels may cause the geared bar 81 to move in vertical direction. Because a synchronized link 80 is firmly connected to a geared bar 81, the rotation of the thumb turn-key may cause the vertical movement of a synchronizing link 80 along the inner face of plate 2 of the housing of a latch. The synchronizing link 80 may engage both upper and lower hooks 54 and 57; it may engage the upper hook 54 through a rocker arm 94, a pushrod 95 and a protrusion 93 made at the tip of the upper portion of the synchronizing link 80, and the lower hook 57 through a protrusion 92 made on the inner surface of the lower portion of the synchronizing link 80. It will be seen that when a turn-key is rotated from unlatched toward latched position a synchronizing link 80 may move upwardly along walls of a housing of a latch. A protrusion 93 made on the tip of the upper portion of the synchronizing link may engage the suspended end of the rocker arm 94 pushing it upward. The opposite end of a rocker arm 94 is pivotally connected to the pushrod 95 which in turn is pivotally connected to the hub portion 60 of the upper hook 54. Because an upper hook 54 is rotatably positioned on the pivotal eccentric cam 76 and may rotate around it, the vertical movement of a pushrod 95 causes the hub portion 60 of an upper hook 54 to rotate around an upper eccentric cam 76. Such vertical movement of the synchronizing link 80 may be limited by the travel limiter 96 that may be passed through the elongated aperture 98 made in the upper portion of the synchronizing link 80 and extends through the upper portion of the link 80 in parallel relation to such link 80. The upper hook 54 may revolve from unlatched position to upright latched position in perpendicular relation to the synchronizing link 80. At the point an upper hook 54 revolves approximately 90 degrees from unlatched position, the further movement of the synchronized link 80 and therefore the revolving movement of the upper hook 54 may be prevented when the travel limiter 96 is pressed against the edge of the elongated aperture 98 made in the upper portion of the synchronizing link 80. A travel limiter 97, an elongated aperture 99 and their positioning in the lower portion of the synchronizing link 80 may be identical to these of an upper one.

An upper and lower eccentric pivot cam 76 and 77 may have a flanges 100 around one side of the cam. The flange 100 may secure the positioning of the cam 76 within the aperture portion 62 of the hook 54 from one side and prevent their disengagement from one side. To prevent the disengagement of the eccentric cam 76 and the hook 54 from the opposite side, the washer 102 may be frictionally and insertably positioned on the cam 76 and may secure the positioning of the cam 76 within the aperture portion 62 of the hook 54 from that side. The position of the flange 101 and the washer 103 on the lower cam 77 may be identical to those on the upper cam 76.

In will be seen that both hooks 54 and 57 are limited from further rotation by travel limiters 96 and 97 upon reaching their unlatched position. But eccentric cams 76 and 77 may freely rotate because they are not affected by travel limiters 96 and 97. There are two torsion springs where each correspondingly connects the washers 102 and 103 with the front wall 15 of the plate 14 in such manner that compressing force of the spring 104 is directed toward rear edges of both plates 2 and 14 when both hooks 54 and 57 reach upright latched position. It would be seen that in such embodiment, although both hooks 54 and 57 remains immovable, both eccentric cams 76 and 77 may rotate around their off-center pins 78 and 79. The springs 104 may force the washers 102 and 103 to rotate toward the direction where such compression force is minimal. Because the washers 102 and 103 are firmly connected with corresponding eccentric cams 76 and 77, the cams 76 and 77 may also rotate around the pins 78 and 79 respectively. In one embodiment, because of the displaced position of the center of rotation of such cams 76 and 77 relative to their geometrical centers, the rotation of the cams 76 and 77 may cause both hooks 54 and 57 to move toward the rear edge of the plates 2 and 14 until hub portions 60 and 61 of both hooks 54 and 57 are pressed against protrusions 105 and 106 formed on rear edges of both plates 2 and 14 and both hooks 54 and 57 are in locked position. The protrusions 105 and 106 may have such shape and be positioned relative to the plates 2 and 14 in such manner that they may prevent rotation of hooks 54 and 57 toward each other.

It will be understood that when the turn-key is rotated from the latched to unlatched position, in one embodiment the synchronizing link 80 may engage both eccentric cams 76 and 77 through protrusions 107 and 108 positioned on such eccentric cams 76 and 77 to rotate backwardly from locked position. Because both hooks 54 and 57 remain immovable, the rotation of both cams 76 and 77 may cause hub portions 60 and 61 of the hooks 54 and 57 to move toward the front edge of the plates 2 and 14 in the direction perpendicular the axis of rotation of both cams 76 and 77 until hub portions 60 and 61 of both hooks 54 and 57 are disengaged with protrusions 105 and 106 made on the rear edge of both plates 2 and 14 and hooks 54 and 57 may rotate. Then the further movement of the synchronizing link 80 may cause the further rotation of both cams until the engagement between link 80 and protrusions 107 and 108 is terminated. At this point of rotation of both cams, the link 80 engages the second set of protrusions 109 and 110 made on the extending portion 111 and 112 correspondingly of the upper and lower cams 76 and 77. At this point, the extending portions of the eccentric cams 76 and 77 engage the protrusions 65 and 66 correspondingly of the hub portions 60 and 61 of the hooks 54 and 57. Thus vertical movement of the synchronized link 80 may cause the rotation of the upper and lower cams 76 and 77 along with both hooks in the direction toward the unlatched position of the upper and lower hooks.

Those skilled in the art will readily appreciate that many modifications of the exemplary embodiment are possible without materially departing from the novel teachings and advantages of this invention. Different types of the resistance providing elements may be used to supply resistance to the movement of the handle from a “folded” to an “opened” position. Alternative mechanisms may provide for the coupling of various parts of the handle, different types of the engagement between the sliding and the pivotal members, between the sliding member and the assembly body, between the pivotal member and the assembly body or between the assembly body and the handle body. Furthermore, alternative shapes and configuration may be used for the sliding member, the pivotal member, the assembly body or the knob. All such variations and modifications intended to be included within the scope if this invention as defined in the following claims.

Other modifications, substitutions, omissions and changes may be made in the design, size, materials used or proportions, operating conditions, arrangement or positioning of elements and members of the preferred embodiment without departing from the spirit of this invention as described in the following claims.

We claim:

1. A multipoint latch of the type appropriate for use in sliding doors, having an enclosure which houses two retractable hooks that work in coaction with two keepers that are set in a door jamb, so as to allow for locking and unlocking of the sliding door, wherein the multipoint door latch comprises:
(a) a pair of symmetrical hooks that are vertically displaced and allowed to rotate and latch when extended and to rotate and unlatch when retracted;
(b) an actuator operative in response to turning movement of a tail member to move a synchronizing plate which thereupon moves said hooks into said latched and unlatched position.

2. The multipoint door latch according to claim 1 wherein said synchronizing plate has a flat surface and a geared bar extending from said flat surface.

3. The multipoint door latch according to claim 1 wherein said geared bar moves a first cam and a second cam wherein each of said cams moves said hooks.

4. The multipoint door latch according to claim 3 wherein said actuator rotates a first and second toothed gear, said first and second toothed gear moving said synchronizing plate.

5. The multipoint door latch according to claim 3 wherein said synchronizing plate is a flat plate having a generally rectangular shape.

6. The multipoint door latch according to claim 3 wherein said synchronizing plate extends from bottom to top of said housing and said synchronizing link is allowed to move freely in a vertical direction in said latch.

7. The synchronizing link according to claim 1 wherein said synchronizing plate has a first surface and a second surface and wherein said second surface is in contact with an inside surface of said housing.

8. The multipoint door latch according to claim 7 wherein said synchronizing plate has a top edge, a bottom edge, and two side edges and wherein said gear bar extends from the first surface of said plate.

9. The multipoint door latch according to claim 8 wherein said gear bar has a top surface and a bottom surface and front face and back face.

10. The multipoint door latch according to claim 9 wherein the back face of said gear bar contacts the front face of said plate and the bottom surface of said gear bar and the bottom edge of said plate are generally in the same plane.

11. The multipoint door latch according to claim 2 wherein said synchronizing plate has a length and width that are less then the length and width of said latch housing.

12. The multipoint door latch according to claim 11 wherein said synchronizing plate has a toothed bar that meshes with two segments of a gear wheel.

13. The multipoint point door latch according to claim 1 wherein said actuator moves two gear segments comprising of:
(a) a pivot arm;
(b) a toothed portion;
(c) a hub portion.

14. The multipoint door latch according to claim 13 wherein said hub portion defines trunnions for journaling in suitable apertures in the housing of latch so as to mount said hub portions of pivot arms for rotation within the housing around pivot arms.

15. The multipoint door latch according to claim 14 wherein said hub portion has a rectangular drive slot sized to drivingly receive a tail member of a thumb turnkey, and a drive slot that extends the width of the housing.

16. The multipoint door latch according to claim 15 wherein said toothed portion has several teeth that mesh with said geared bar in such a manner that rotation of the tail member causes rotation of said gear segments around their respective axis.

17. A multipoint latch of the type appropriate for use in sliding doors, said latch having a housing assembly sized to fit within the opening in the lock face of a stile of a sliding door, said housing having a toothed bar that meshes with a segment of a first and a second gear wheel, said segments comprising a toothed portion and a hub portion, said gear wheel having a pivot arm for rotatable motion within the housing about a pivot axis, said hub portion including an aperture for receiving a tail member to move said gear wheel and wherein the movement of said gear wheel causes a synchronizing plate to slide from a first position to a second position, said movement of said synchronizing plate causing a hook portion of upper and lower hook assemblies to move from a first position to a second position.

18. The multipoint latch according to claim 17 wherein said gear segments have a hub portion and an aperture portion configured in the hub portion, said aperture portion having a pivotal eccentric cam freely rotatable within the aperture portion.

19. The multipoint latch according to claim 18 wherein said eccentric cam is freely rotatable within the aperture independently of said hook portion of said upper and lower hook assemblies.

20. The multipoint latch according to claim 19 wherein said eccentric cam has a pivotal pin having a geometric center displaced from the geometric center of the eccentric cam.

21. The multipoint latch according to claim 17 wherein each of said hook portions can move between an unlatched or retracted position and a latched or extended position that is generally perpendicular to the axis of rotation of the cam.

22. The multipoint latch according to claim 17 wherein said hub portion has one or more protrusions and the eccentric cam has one or more grooves or protrusions such that said hook cannot rotate reversedly through the interconnection of said grooves and protrusions of the hub portion and the eccentric cam.

23. The multipoint latch according to claim 17 further comprising an actuator assembly, including an actuator in form of a rack-and-pinion and a synchronizing link in the form of elongated rectangular place that is fixed to a toothed bar of the actuator wherein the rotating movement of the actuator causes the synchronizing link to move vertically along the housing assembly.

24. The multipoint latch according to claim 19 wherein the synchronizing link further has elongated apertures with two ends of said apertures defining two limited positions of travel through the co-action with travel limiters on said housing.

25. The multipoint latch according to claim 20 further comprising torsion springs that bias the hooks in the unlatched or retracted position and the extended or latched position.
